(19) United States
(12) Patent Application Publication
(10) Pub. No.: US 2024/0345717 A1
(43) Pub. Date: Oct. 17, 2024

(54) OPERATION METHOD AND APPARATUS, AND ELECTRONIC DEVICE AND COMPUTER-READABLE STORAGE MEDIUM

(71) Applicant: BOE TECHNOLOGY GROUP CO., LTD., Beijing (CN)

(72) Inventor: Heng LIU, Beijing (CN)

(21) Appl. No.: 18/701,051

(22) PCT Filed: Jan. 10, 2023
(86) PCT No.: PCT/CN2023/071499

§ 371 Date: Apr. 12, 2024

(30) Foreign Application Priority Data
Jan. 12, 2022 (CN) 202210031940.1

(51) Int. Cl. G06F 3/0486; G06F 3/0481

(52) U.S. Cl. CPC G06F 3/0486; G06F 3/0481

(57) ABSTRACT

An operation method, an apparatus, an electronic device and a computer-readable storage medium are provided. The operation method includes: acquiring a first movement operation which is performed on a first sub-control in a first control, the first sub-control being located in an area range of the first control; in response to the first movement operation meeting a first response condition of the first control and meeting a second response condition of the first sub-control, responding to the first movement operation by the first control; and in response to the first movement operation not meeting the first response condition but meeting the second response condition, responding to the first movement operation by the first sub-control to generate visual movement.

### CROSS-REFERENCE TO THE RELATED APPLICATION

The present application claims priority of Chinese Patent Application No. 202210031940.1, filed on Jan. 12, 2022, the disclosure of which is hereby incorporated herein by reference in its entirety as part of the present disclosure.

### TECHNICAL FIELD

Embodiments of the present disclosure relate to an operation method, an apparatus, an electronic device and a computer-readable storage medium.

### BACKGROUND

With the development of electronic technology and internet technology, electronic devices provide increasingly diverse functions, thereby making people's lives more intelligent. For example, technologies such as smart cities, smart parks, and smart enterprises utilize new generation information technologies such as the Internet of Things, cloud computing, big data, spatial information integration, and so on to promote cities, parks, or enterprises to enter into intelligent models for service, management, and construction.

Technologies such as smart cities, smart parks, and smart enterprises often display data or image information to users through touch screens. Multiple controls are often displayed on touch screens, thus allowing users to interact with the touch screen through these controls.

### SUMMARY

At least one embodiment of the present disclosure provides an operation method, which comprises: acquiring a first movement operation which is performed on a first sub-control in a first control, the first sub-control being located in an area range of the first control; in response to the first movement operation meeting a first response condition of the first control and meeting a second response condition of the first sub-control, responding to the first movement operation by the first control; and in response to the first movement operation not meeting the first response condition but meeting the second response condition, responding to the first movement operation by the first sub-control to generate visual movement.

For example, in the operation method provided by an embodiment of the present disclosure, the first control comprises a list control, the first sub-control comprises a drag control, and the drag control is a control which is capable of being dragged.

For example, in the operation method provided by an embodiment of the present disclosure. N sub-controls are in the area range of the first control, N is an integer greater than 1, the N sub-controls are arranged in the first control in sequence, and the first sub-control is one of the N sub-controls.

For example, in the operation method provided by an embodiment of the present disclosure, the first control comprises a list control. In response to the first movement operation meeting the first response condition of the first control and meeting the second response condition of the first sub-control, responding to the first movement operation by the first control, comprises: in response to the first movement operation meeting the first response condition and meeting the second response condition, by the list control, visually rolling the N sub-controls in the list control.

For example, in the operation method provided by an embodiment of the present disclosure, the first movement operation comprises a slide operation.

For example, in the operation method provided by an embodiment of the present disclosure, the first response condition is a subset of the second response condition.

For example, in the operation method provided by an embodiment of the present disclosure the second response condition comprises: a slide distance of the slide operation being greater than a distance threshold. The first response condition comprises: the slide distance of the slide operation being greater than the distance threshold, and a slide direction of the slide operation being within a preset range.

For example, in the operation method provided by an embodiment of the present disclosure, the first response condition comprises: a slide distance of the slide operation being greater than a distance threshold, and a slide direction of the slide operation being within a preset range. The second response condition comprises: the slide distance of the slide operation being greater than the distance threshold, and the slide direction of the slide operation being outside the preset range.

For example, in the operation method provided by an embodiment of the present disclosure, the slide direction of the slide operation being within the preset range comprises: an angle between the slide direction of the slide operation and an extension direction of the first control being within the preset range.

For example, in the operation method provided by an embodiment of the present disclosure, the extension direction is a horizontal direction, and in response to a first distance sliding by the slide operation in the horizontal direction being greater than a second distance sliding by the slide operation in a vertical direction, the angle between the slide direction and the extension direction of the first control is within the preset range; or, the extension direction is the vertical direction, and in response to the first distance sliding by the slide operation in the horizontal direction being less than the second distance sliding by the slide operation in the vertical direction, the angle between the slide direction and the extension direction of the first control is within the preset range. The horizontal direction is perpendicular to the vertical direction.

For example, in the operation method provided by an embodiment of the present disclosure, in response to the first movement operation not meeting the first response condition but meeting the second response condition, responding to the first movement operation by the first sub-control to generate visual movement, comprises: in response to the first movement operation not meeting the first response condition but meeting the second response condition, generating an auxiliary control of the drag control; and allowing the auxiliary control to move with the first movement operation.

For example, in the operation method provided by an embodiment of the present disclosure, the auxiliary control moves outside the area range of the first control according to the first movement operation.

For example, in the operation method provided by an embodiment of the present disclosure, the first control and the first sub-control are displayed on a display page, the display page further comprises a second control which is outside the area range of the first control, the first sub-control comprises a display window and displays image data, and the method further comprises: in response to the auxiliary control moving into an area range of the second control and stopping moving, providing the image data to the second control by the first sub-control, and displaying the image data by a display window of the second control.

For example, in the operation method provided by an embodiment of the present disclosure, a second sub-control is within the area range of the first control, and the method further comprises: acquiring a second movement operation which is performed on the second sub-control, the second movement operation being used to adjust the second sub-control from a first position to a second position; and displaying the image data displayed by the second sub-control by a sub-control corresponding to the second position.

For example, in the operation method provided by an embodiment of the present disclosure, the second movement operation comprises a press operation to the second sub-control and a selecting operation to the second position, and a duration of the press operation is longer than a preset duration.

For example, in the operation method provided by an embodiment of the present disclosure, the display page comprises a first display area, a second display area, and a third display area, the first control is located in the first display area, the second display area comprises a plurality of second controls, each second control is used for displaying image data from one of a plurality of sub-controls, the third display area is configured to display at least one layout strategy, each layout strategy indicates a layout method used for arranging the plurality of second controls, or indicates sub-controls respectively corresponding to the plurality of second controls, so as to allow each second control to display image data from a sub-control corresponding to the second control.

For example, in the operation method provided by an embodiment of the present disclosure, the third display area is further configured to display at least one display strategy, and the display strategy indicates relationship between the layout strategy and a time period, so as to display the layout strategy corresponding to each time period in each time period.

For example, in the operation method provided by an embodiment of the present disclosure, the first control, the first sub-control, and the second control are obtained based on cross-platform interface development framework or obtained based on an operation system.

For example, in the operation method provided by an embodiment of the present disclosure, the first control is a drag control, and the first sub-control is a list control. Responding to the first movement operation by the first control comprises: allowing the drag control to move with the first movement operation. Responding to the first movement operation by the first sub-control to generate visual movement comprises: allowing a sub-element of the list control to visually roll in the list control.

At least one embodiment of the present disclosure further provides an operation apparatus, which comprises: an acquiring unit, configured to acquire a first movement operation which is performed on a first sub-control in a first control, the first sub-control being located in an area range of the first control; a first response unit, configured to respond to the first movement operation by the first control in response to the first movement operation meeting a first response condition of the first control and meeting a second response condition of the first sub-control; and a second response unit, configured to respond to the first movement operation by the first sub-control to generate visual movement in response to the first movement operation not meeting the first response condition but meeting the second response condition.

At least one embodiment of the present disclosure further provides an electronic device, which comprises a processor and a memory. The memory comprises one or more computer program instructions. The one or more computer program instructions are stored in the memory, and implement the operation method provided by any one of the embodiments of the present disclosure when executed by the processor.

At least one embodiment of the present disclosure further provides a computer-readable storage medium, which stores computer-readable instructions in a nonvolatile way. When the computer-readable instructions are executed by a processor, the operation method provided by any one of the embodiments of the present disclosure is implemented.

### BRIEF DESCRIPTION OF THE DRAWINGS

To explain the technical scheme of the embodiments of the present disclosure more clearly, the drawings used in the description of the embodiments will be briefly described in the following. It is obvious that the drawings described below are only related to some embodiments of the present disclosure, rather than limits to this disclosure.

FIG. 1A is a schematic flow diagram of an operation method provided by at least one of the embodiments of the present disclosure;

FIG. 1B is a schematic diagram of a first control and a first sub-control provided by at least one of the embodiments of the present disclosure;

FIG. 1C is a schematic diagram of an angle between the slide direction of the slide operation and an extension direction of the first control being within the preset range provided by at least one of the embodiments of the present disclosure;

FIG. 1D is a schematic diagram of another first control and another first sub-control provided by at least one of the embodiments of the present disclosure;

FIG. 1E is a schematic diagram of the result from N sub-controls of FIG. 1B visually rolling in the first control.

FIG. 2A is a schematic diagram of an auxiliary control moving with the first movement operation provided by at least one of the embodiments of the present disclosure;

FIG. 2B is a schematic diagram of a first control and a first sub-control responding to the first movement operation provided by at least one of the embodiments of the present disclosure;

FIG. 3 is a schematic flow diagram of another operation method provided by at least one of the embodiments of the present disclosure;

FIG. 4 is a schematic block diagram of an operation apparatus provided by at least one of the embodiments of the present disclosure;

FIG. 5 is a schematic block diagram of an electronic device provided by at least one of the embodiments of the present disclosure;

FIG. 6 is a schematic block diagram of another electronic device provided by at least one of the embodiments of the present disclosure; and

FIG. 7 is a schematic diagram of a computer-readable storage medium provided by at least one of the embodiments of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” “the,” etc., are not intended to limit the amount, but indicate the existence of at least one. The terms “comprise,” “comprising,” “include,” “including.” etc., are intended to specify that the elements or the objects stated before these terms encompass the elements or the objects and equivalents thereof listed after these terms, but do not preclude the other elements or objects. The phrases “connect”, “connected”, “coupled”, etc. . . . are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

As the functions provided by electronic devices become increasingly diverse, the interaction between electronic devices and users is also increasing. In order to facilitate the interaction between users and electronic devices, the types of controls are becoming increasingly diverse. For example, some controls can be moved, others can be clicked, and so on. For example, a control can include sub-controls, and users can operate the control and sub-controls separately. However, in the case that a control includes sub-controls, operations on the control and the sub-controls are prone to conflicts. For example, when a user wants to control a control, the user's operations are taken by the sub-controls, resulting in controlling of the sub-controls, instead of controlling of the control, which seriously affects the user experience.

At least one embodiment of the present disclosure provides an operation method, an operation apparatus, an electronic device, and a computer-readable storage medium. The operation method comprises; acquiring a first movement operation which is performed on a first sub-control in a first control, the first sub-control being located in an area range of the first control; in response to the first movement operation meeting a first response condition of the first control and meeting a second response condition of the first sub-control, responding to the first movement operation by the first control; and in response to the first movement operation not meeting the first response condition but meeting the second response condition, responding to the first movement operation by the first sub-control to generate visual movement. This operation method can alleviate the problem of operations conflicts between controlling the first control and controlling the first sub-control.

It should be noted that the embodiments provided in this disclosure can be applied to any scenario of controlling a control, and are not limited to the application scenarios mentioned below. That is to say, the present disclosure does not limit the application scenarios of the disclosed embodiments.

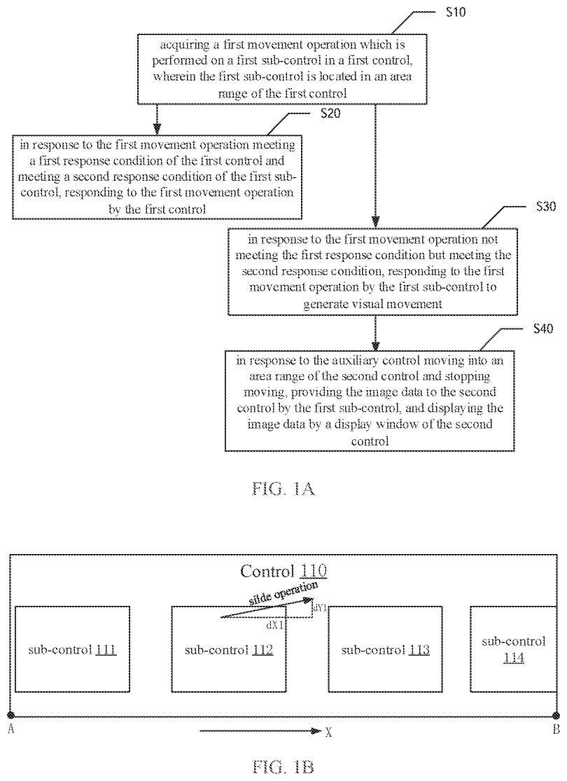

FIG. 1A is a schematic flow diagram of an operation method provided by at least one of the embodiments of the present disclosure.

As illustrated in FIG. 1A, this method can include steps S10 to S30.

Step S10: acquiring a first movement operation which is performed on a first sub-control in a first control, the first sub-control being located in an area range of the first control.

Step S20: in response to the first movement operation meeting a first response condition of the first control and meeting a second response condition of the first sub-control, responding to the first movement operation by the first control.

Step S30: in response to the first movement operation not meeting the first response condition but meeting the second response condition, responding to the first movement operation by the first sub-control to generate visual movement.

For step S10, for example, the first control can be a list control, the first sub-control includes a drag control, and the drag control is a control which can be dragged. For example, the first move operation can be a slide operation, and the list control can respond to the slide operation to allow the drag control to visually roll within the list control, the drag control can also be dragged to other positions in response to the slide operation. Because both the list control and drag control can respond to slide operations, it is easy to cause operational conflicts. For example, a user wants to control a list control while the drag control is controlled instead, or a user wants to control a drag control while the list control is controlled instead.

For example, the first control can be a drag control, and the first sub-control can be a click control that receives click operations. For example, the drag control may be dragged in response to click operations, while the click control may be moved in response to click operations. Because both the drag control and click control can respond to click operations, it is easy to cause operational conflicts.

For example, the first control is a drag control, and the first sub-control is a list control. The drag control is dragged to other positions in response to a slide operation, while the list control causes multiple elements in the list control to roll in response to a slide operation. In this situation, both the first control and the first sub-control can respond to slide operations, which can easily lead to operation conflicts.

The embodiments provided in this disclosure can alleviate the problem of operation conflicts between the first control and the first sub-control.

FIG. 1B is a schematic diagram of a first control and a first sub-control provided by at least one of the embodiments of the present disclosure. The operation method illustrated in FIG. 1A is explained in conjunction with FIG. 1B below.

As illustrated in FIG. 1B, sub-controls 111, 112, 113, and 114 are located within the area range of a control 110. The control 110 is an example of the first control, and any one of the sub-controls 111, 112, 113, and 114 can serve as the first sub-control. In the embodiments of the present disclosure, the area range of the control can refer to the actual display area of the control on the display page. For example, the control 110 is a list control, and the area range of the control 110 is the viewport of the control 110, which is the actual display area of the list control. The amount of sub-controls contained in the control 110 itself is usually greater than the amount of sub-controls displayed in the viewport.

It should be understood that although FIG. 1B illustrates four sub-controls, it does not mean that the area range of the control can only contain four sub-controls. In fact, in the embodiments of the present disclosure, the area range of the control can include N sub-controls, where N is an integer greater than or equal to 1. Due to the limitations of size of the control 110 itself (such as length), the control 110 can only display parts of the N sub-controls within the area region, such as only 1, 2, or 3 sub-controls, where N is an integer greater than or equal to 1. This disclosure does not limit the amount of sub-controls that can be displayed within the area range of the control 110 according to the size of the control 110, as well as the total amount of sub-controls.

In the example in FIG. 1B, the control 110 is, for example, a list control, and each of the sub-controls 111, 112, 113, and 114 is, for example, a drag control. That is, multiple sub-elements of the list are multiple drag controls. The sub-controls 111, 112, 113, and 114 can be dragged to areas outside the area range of the control 110.

In some other embodiments of the present disclosure, for example, the control 110 is a drag control, and each of the sub-controls 111, 112, 113, and 114 is a list control. That is, multiple sub-elements of the drag control are multiple list controls. In this case, the drag control, i.e., the control 110, can be dragged to the target area, and the drag control and the list control which serves as sub-elements can adaptively adjust their own size according to the size of the target area range, so as to adapt to the size of the target area.

In some embodiments of the present disclosure, N sub-controls can be sequentially arranged in the first control.

For example, N sub-controls can be arranged sequentially along the extension direction of the first control. As illustrated in FIG. 1B, the control 110 extends along the X direction, and N sub-controls (e.g., sub-control 111, sub-control 112, sub-control 113, and sub-control 114) are arranged sequentially along the X direction within the area range of the control. Arrangement along the extension direction of the control can display more sub-controls in a concise and intuitive manner.

In some other embodiments of this disclosure, N sub-controls can also be arranged in the control according to a preset arrangement pattern, which can improve aesthetics and fun.

For step S10, for example, the first move operation is a slide operation. For example, users can perform a slide operation within the area range of the first control. For example, this operation method is applied to a touch screen, and the touch screen can obtain slide operations on any sub-control in the control 110. As illustrated in FIG. 1B, for example, a slide operation on the sub-control 112 is obtained.

As mentioned above, the first move operation can also be a click operation or other operations, and this disclosure does not limit the first move operation.

For steps S20 and S30, for embodiments where the first move operation is a slide operation, for example, the first response condition may be a subset of the second response condition. For example, the second response condition is that the slide distance of the slide operation is greater than the distance threshold. The first response condition is that the slide distance of the slide operation is greater than the distance threshold, and the slide direction of the slide operation is within the preset range. That is, when the slide direction of the first movement operation is within the preset range and the slide distance is greater than the distance threshold, the first control responds to the first movement operation. When the slide direction of the first movement operation is not within the preset range and the slide distance is greater than the distance threshold, the first sub-control responds to the movement operation.

In some other embodiments of the present disclosure, the first response condition and the second response condition may be two mutually independent conditions, for example, the first response condition is that the time duration of the movement operation is less than the preset duration, and the second response condition is that the slide distance is greater than the distance threshold. That is, when the duration of the first movement operation is less than the preset duration and the slide distance is greater than the distance threshold, the first control responds to the first movement operation. When the duration of the first movement operation is greater than or equal to the preset duration and the slide distance is greater than the distance threshold, the first sub-control responds to the movement operation.

In some other embodiments of the present disclosure, the first response condition includes: the slide distance of the slide operation is greater than the distance threshold, and the slide direction of the slide operation is within a preset range. The second response condition includes: the slide distance of the slide operation is greater than the distance threshold, and the slide direction of the slide operation is outside the preset range. For example, the first response condition is that the slide distance of the slide operation is greater than the distance threshold, and the angle between the slide direction of the slide operation and the extension direction of the first control is within the preset range. The second response condition is that the slide distance of the slide operation is greater than the distance threshold, and the angle between the slide direction of the slide operation and the extension direction of the first control is outside the preset range.

Technicians in the art can set the first response condition and second response condition according to the actual needs of the scene, and this disclosure will not provide examples one by one for explanation.

In some embodiments of the present disclosure, setting the second response condition as that the slide distance of the slide operation is greater than the distance threshold can prevent misjudgment caused by finger shaking, etc., and can improve the accuracy of the response.

In some embodiments of the present disclosure, the distance threshold may be, for example, a distance of 18 pixels. When the slide distance is greater than a distance of 18 pixels, it is determined that the slide operation is generated.

For example, when the slide distance obtained from the touch screen for the slide operation on the sub-control 112 is greater than the distance threshold, and the slide direction is within the preset range, the slide operation is responded by the control 110; and when the slide distance obtained from the touch screen for the slide operation on the sub-control 112 is less than or equal to the distance threshold, and the slide direction is not within the preset range, the sub-control 112 responds to the sliding operation.

The distance threshold and preset range can be set by technical personnel in the art based on actual needs, and this disclosure is not limited in this aspect.

In some embodiments of the present disclosure, the slide direction of the slide operation being within a preset range includes: the angle between the slide direction of the slide operation and the extension direction of the first control is within the preset range.

FIG. 1C is a schematic diagram of an angle between the slide direction of the slide operation and an extension direction of the first control being within the preset range provided by at least one of the embodiments of the present disclosure.

As illustrated in FIG. 1C, the extension direction of the first control is the X direction in FIG. 1B. The preset range can be, for example, [0°, 45°], [−45°, 0°], [135°, 180°], or [−180°, −135°]. For example, when the slide direction of the slide operation is within the range illustrated in S1 in FIG. 1C, the control 110 responds to the first movement operation. For example, when the slide direction of the slide operation is within the range illustrated in S2 in FIG. 1C, the sub-control targeted by the first movement operation responds to the first movement operation.

In some embodiments of the present disclosure, for example, if the extension direction is horizontal direction, in response to the first distance of the slide operation slid in the horizontal direction being greater than the second distance of the slide operation slid in the vertical direction, the angle between the slide direction and the extension direction of the first control is within the preset range. For example, the horizontal direction is the X direction illustrated in FIG. 1B and FIG. 1C, and the vertical direction is the Y direction perpendicular to the X direction. As illustrated in FIG. 1B, when the distance dX1 of the slide operation in the X direction is greater than the distance dY1 of the slide operation in the Y direction, it is determined that the angle between the slide direction and the extension direction of the first control is within the preset range. The distance dX1 is an example of the first distance, and the distance dY1 is an example of the second distance.

For example, if the extension direction is vertical direction, the angle between the slide direction and the extension direction of the first control is within the preset range in response to the first distance of the slide operation slid in the horizontal direction being smaller than the second distance of the slide operation slid in the vertical direction.

FIG. 1D is a schematic diagram of another first control and another first sub-control provided by at least one of the embodiments of the present disclosure.

As illustrated in FIG. 1D, this schematic diagram includes a control 120 and sub-controls 121, 122, 123, and 124. The control 120 is another example of the first control, and the sub-controls 121, 122, 123, and 124 are other examples of the first sub-control.

As illustrated in FIG. 1D, the extension direction of the control 120 is vertical direction, for example, the vertical direction is the Y direction, and the direction perpendicular to the Y direction is the horizontal direction. If the distance dX2 of the slide operation slid in the horizontal direction is less than the distance dY2 of the slide operation slid in the Y direction, the angle between the slide direction and the extension direction of the control 120 is within the preset range.

By comparing the movement distance in the vertical direction and horizontal direction, it is easy to determine whether the angle between the slide direction and the extension direction of the first control is within the preset range.

In some embodiments of the present disclosure, for example, the slide distances in the X direction and Y direction can be calculated based on the coordinates of the starting point of the slide operation and the coordinates of the ending point of the slide operation.

In some embodiments of the present disclosure, step S20 may include: in response to the first movement operation meeting the first response condition and meeting the second response condition, the list control causes the first sub-control to visually roll within the list control.

For example, as illustrated in FIG. 1B and FIG. 1D, in response to the first move operation performed on the sub-control 112 or sub-control 122 meeting the first response condition and second response condition, N sub-controls visually roll within the list control.

FIG. 1E is a schematic diagram of the result from N sub-controls of FIG. 1B visually rolling in the list control.

For example, in response to the movement operation on the sub-control 113 in FIG. 1B along the negative direction of X-axis, multiple sub-controls roll within the area range of the first control 110, i.e., the list control, as illustrated in FIG. 1E, and ultimately, sub-controls 114 to 117 are displayed within the area range of the control 110.

The list control allowing N sub-controls to visually roll within the list control includes: the list control calculating and obtaining multiple target sub-controls located within the area range based on the movement distance of the movement operation, determining the display position of each target sub-control within the area range, and rendering at the display position so as to display the corresponding target sub-control.

For example, multiple target sub-controls within the area range can be calculated based on the coordinates of control 110 and multiple sub-controls, as well as the movement distances. For example, based on the movement distance d (d>0) of the movement operation, the change in the coordinate values of the sub-control is calculated as a×d. The target sub-controls located within the area range of the control 110 is determined based on the coordinate values of the endpoint of control 110 and the variation of the coordinate values of each sub-control. For example, in the scenario illustrated in FIG. 1B, it is assumed that a is equal to 2, endpoint A of control 110 has a coordinate value of 10 in the X direction, and endpoint B has a coordinate value of 40 in the X direction. In response to the slide operation on the sub-control 113 in the negative direction of X direction has a slide distance d of 6 cm (greater than the distance threshold), the coordinate value of each sub-control in the X direction is reduced by 2×6 cm, which means a reduction of 12 cm After the coordinate values of each sub-control are updated, it is determined that the sub-controls 114˜117 are displayed within the area range of control 110, and after the coordinate values are updated, the display positions of the sub-controls 114˜117 within the area range are determined. Then, the corresponding sub-controls 114 to 117 are obtained by rendering at each display position, and finally the display results illustrated in FIG. 1E is obtained. For example, the 2D vector graphics processing function library (SKIA) engine can be used to render at each display position, so as to obtain corresponding sub-controls 114 to 117.

In some embodiments of the present disclosure, the sub-control includes a drag control, and step S30 may include: generating an auxiliary control for the drag control in response to a first movement operation not meeting the first response condition but meeting the second response condition; and the auxiliary control moving with the first movement operation.

In some embodiments of the present disclosure, the display style of the auxiliary control may be the same as that of the first sub-control, or the display style of the auxiliary control may be different from that of the first sub-control.

In some embodiments of the present disclosure, for example, the first sub-control may be obtained based on a cross-platform interface development framework. For example, the first sub-control is a drag control, which can be a Draggable series component provided by the Flutter framework. In the Flutter framework, the Draggable component has two essential parameters, one is the child parameter, which is used to indicate the sub-control, and the other is the feedback parameter, which indicates the component that move with the movement when dragging, that is, the auxiliary control. When dragging, the childWhenDragging parameter can be used to set the display style of the auxiliary control.

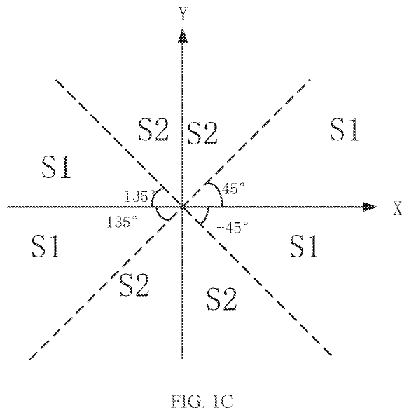

FIG. 2A is a schematic diagram of an auxiliary control moving with the first movement operation provided by at least one of the embodiments of the present disclosure.

As illustrated in FIG. 2A, the display page 200 includes control 110, and the viewport of the control 110 displays sub-controls 111, 112, 113, and 114. The control 110 is displayed in the first display area 210 (the area indicated by the dashed line in FIG. 2A is the first display area), and the area range of the control 110 refers to the area indicated by the solid line in FIG. 2A, which includes the sub-controls 111, 112, 113, and 114.

For example, if the fingers perform slide operation on the sub-control 112 on the touch screen and the slide operation is not within the preset range of the slide direction, the sub-control 112 responds to the movement operation. For example, the sub-control 112 generates an auxiliary control 1121 in response to the movement operation.

As illustrated in FIG. 2A, for example, the auxiliary control 1121 moves with the movement of the finger, and for example, the auxiliary control 1121 can be displayed at the position where the finger is located.

In some embodiments of the present disclosure, the auxiliary control moves outside the area range of the first control according to the first movement operation. As illustrated in FIG. 2A, for example, the auxiliary control 1121 is dragged to a position outside the area range of the first control 110.

In some embodiments of the present disclosure, for example, if the slide operation does not meet the first response condition but meets the second response condition, the sub-control directly obtains control right to respond to the slide operation. If the slide operation meets the first response condition and meets the second response condition, the sub-control does not obtain the control right. After sliding for a certain distance, because the sub-control still does not obtain the control right, the control right is handed over to the control, so that the control responds to the slide operation.

In some embodiments of the present disclosure, the first control and the first sub-control are displayed on a display page, and the display page also includes a second control located outside the area range of the first control. The first sub-control includes a display window and displays image data. As illustrated in FIG. 1A, in this embodiment, the operation method may also include step S40.

Step S40: in response to the auxiliary control moving into the area range of the second control and stopping moving, the first sub-control provides image data to the second control, and the image data is displayed by the display window of the second control.

As illustrated in FIG. 2A, the first control and first sub-control are displayed on the display page 200, and the display page 200 also includes a second control 130 located outside the control 110. The sub-control 112 includes a display window to display image data.

If the auxiliary control 1121 moves within the area range of the second control 130 and the movement operation stops, the sub-control 112 provides the image data to the second control 130, causing the display window of the second control 130 to display the image data.

For example, the display area of the display window of the second control 130 is larger than that of the display window of the sub-control 112, which is used for zooming in and displaying image data for easy observation.

By allowing the auxiliary control to move into the area range of the second control with the movement operation, it is visually intuitive to feel the sub-control being moved and the position it has been moved to, thereby convenient for stopping the movement operation timely, so that the sub-control is visually moved to the target position with high accuracy (i.e., the position where the second control is located).

In some other embodiments of the present disclosure, for example, the first control is a drag control, and the area range of the drag control includes multiple sub-controls, each of which is a list control. In this embodiment, in response to the first movement operation meeting the first response condition and meeting the second response condition, the first control. i.e., the drag control, moves with the first movement operation; in response to the first move operation not meeting the first response condition but meeting the second response condition, the sub-elements in the first sub-control, i.e., the list control, visually roll in the list control.

FIG. 2B is a schematic diagram of a first control and a first sub-control responding to the first movement operation provided by at least one of the embodiments of the present disclosure.

As illustrated in FIG. 2B, a drag control 310 and list controls 311-314 are displayed on a display page 300. The drag control 310 is an example of the first control, and any one of the list controls 311-314 can be an example of the first sub-control.

In the example illustrated in FIG. 2B, the list controls 311-314 are displayed in a scroll manner, but this disclosure is not limited to this scroll manner. For example, the list control includes a slider and is displayed in a slider manner.

As illustrated in FIG. 2B, the display page 300 includes a display area 301 and a display area 302. Before performing movement operation on the drag control 310 and the list controls 311-314, as illustrated in FIG. 2B, the drag control 310 is located in the display area 301, and the list controls 311-314 are sequentially arranged within the area range of the drag control 310.

In this embodiment, for example, the first response condition of the drag control 310 is that the slide direction of the slide operation is within the range of [45°, 90°] illustrated in FIG. 1C, and the sliding distance is greater than the preset distance. The second response condition of the list controls 311-314 is that the slide distance is greater than the preset distance.

For example, when performing a slide operation on the list control 312, if the slide direction of the slide operation is within the range of [45°, 90°] illustrated in FIG. 1C, and the slide distance is greater than the preset distance, the drag control 310 moves in response to the slide operation. For example, the drag control 310 moves with the slide operation from the display area 301 to the display area 302.

In some embodiments of the present disclosure, the display areas of the display area 301 and the display area 302 are different, and the drag control 310 and list control 311-314 can adaptively adjust their own size based on the display area of the display area 301 or the display area 302. For example, when the drag control 310 is moved to the display area 302, the drag control 310 and list controls 311-314 are enlarged relative to themselves when displayed in the display area 301.

For example, if the slide direction of the slide operation is not within the range of [45°, 90°] illustrated in FIG. 1C, and the slide distance is greater than the preset distance, the list control targeted by the slide operation responds to the slide operation.

For example, after the drag control 310 is moved to the display area 302, a slide operation is performed on the list control 313. If the slide direction of the slide operation on the list control 313 is not within the range of [45°, 90°] illustrated in FIG. 1C, and the slide distance is greater than the preset distance, the slide operation is responded to by the list control 313. For example, as illustrated in FIG. 2B, if a slide operation is performed on the list control 313 along the negative direction of the Y-axis illustrated in FIG. 1C in the display area 302, and the slide distance is greater than the preset distance, the list control 313 responds to the slide operation.

In this embodiment, the visual movement generated by the list control in response to a slide operation can be visual rolling of sub-elements in the list control.

In some embodiments of the present disclosure, the area range of the first control also includes a second sub-control. The second sub-control can be the same sub-control as the first sub-control mentioned above, or it can be a different sub-control. For example, in the scenario illustrated in FIG. 1B, the first sub-control is the sub-control 111, the second sub-control can be the sub-control 112, the sub-control 113, or the sub-control 114, and of course, the second sub-control can also be the sub-control 111.

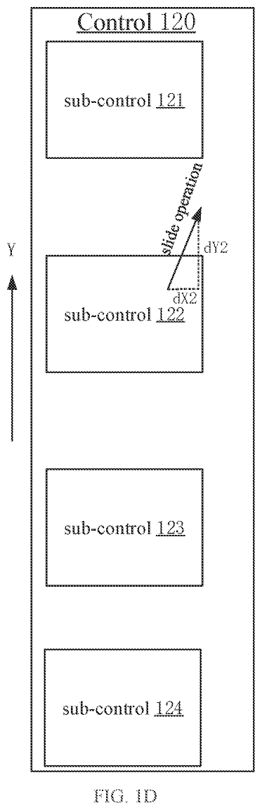

FIG. 3 is a schematic flow diagram of another operation method provided by at least one of the embodiments of the present disclosure.

As illustrated in FIG. 3, this operation method can also include steps S50 and S60 on the basis of the operation method illustrated in FIG. 1A, which includes steps S10-S40. Steps S50 and S60 can be executed before step S10 or after step S40.

Step S50: acquiring the second move operation performed on the second sub-control, which is used to adjust the second sub-control from the first position to the second position.

Step S60: displaying the image data displayed by the second sub-control by a sub-control corresponding to the second position, so that the second sub-control is visually adjusted to the second position.

This method can adjust the position of sub-controls in the control, enhance the diversity of human-computer interaction, and facilitate the operation and control of sub-controls and controls.

For step S50, the second movement operation includes a press operation to the second sub-control and a selecting operation to the second position, with the duration of the press operation greater than the preset duration.

The duration of the press operation is greater than the preset duration to prevent misjudgment caused by hand shaking and other operations. The press operation with a duration greater than the preset duration is referred to as a long press operation.

The preset duration can be, for example, 2s, 3s, etc., technicians in the art can set the preset duration themselves.

In some embodiments of the present disclosure, for example, the selection operation of the second position may be a click operation performed at the second position. For example, the second movement operation can be a long press operation on the sub-control 114 and a click operation on position P0.

In some other embodiments of the present disclosure, for example, the second movement operation may be a long press operation on a sub-control, and after the long press operation, the sub-control is dragged until the sub-control is dragged to the second position, then the sub-control is stopped to be dragged and is released. In this embodiment, the selection operation for the second position is to stop dragging and release the sub-control when the sub-control is dragged to the second position. Releasing the sub-control means, for example, fingers or other operators that operate the touch screen leave the touch screen. For example, as illustrated in FIG. 2A, a long press operation is performed on the sub-control 114, and after the long press operation, the fingers slide on the touch screen along the trajectory illustrated by the solid line. When the fingers slide to position P0, the sliding stops and the sub-control 114 is released. Position P0 is an example of the second position.

For step S60, the sub-control corresponding to the second position can be a sub-control closest to the second position, for example.

For example, the sub-control corresponding to the second position P0 is the sub-control 112, which displays the image data displayed by the sub-control 114.

In some embodiments of the present disclosure, displaying the image data displayed by the second sub-control by the sub-control corresponding to the second position includes: the visual exchange of position between the sub-control corresponding to the second position and the second sub-control. As illustrated in FIG. 2A, executing step S60 causes the sub-control 114 and the control 112 to visually exchange positions.

In some embodiments of the present disclosure, visually exchanging positions can refer to the fact that the positions of two sub-controls have not changed substantially, but the image data displayed by the two sub-controls have been exchanged, thus visually reflecting the exchange of positions between the two sub-controls. For example, the image data of the sub-control 114 changes from the first image data to the second image data, and the image data of the sub-control 112 changes from the second image data to the first image data, which can appear to exchange the position of the sub-control 114 with the position of the sub-control 112.

In some other embodiments of the present disclosure, visually exchanging positions can be achieved by drawing a sub-control 114 according to its properties at the current position of the sub-control 112, and drawing the sub-control 112 according to its properties at the current position of the sub-control 114, thereby achieving the exchange of positions between the two sub-controls. Here, the SKIA engine mentioned above can be used to draw sub-controls at corresponding positions.

In this embodiment, if step S60 is executed, the arrangement order of the sub-controls displayed in the control 110 is: sub-control 111, sub-control 114, sub-control 113, and sub-control 112.

In some embodiments of the present disclosure, the image data displayed by the second sub-control is displayed by the sub-control corresponding to the second position, which includes: the second sub-control is visually inserted between two adjacent sub-controls, and the two adjacent sub-controls include a sub-control corresponding to the second position.

As illustrated in FIG. 2A, the sub-control 114 is visually inserted between the sub-control 112 and the sub-control 111. In this embodiment, if step S60 is executed, the arrangement order of the sub-controls displayed in the control 110 is: sub-control 111, sub-control 114, sub-control 112, and sub-control 113.

In some embodiments of the present disclosure, the position of each sub-control may not change, but the sub-control 112 may display image data of the sub-control 114, the sub-control 113 may display image data of the sub-control 112, the sub-control 114 may display image data of the sub-control 113, and so on, so as to achieve visual movement.

In some other embodiments of the present disclosure, a sub-control 114 can be drawn according to its properties at the current position of the sub-control 112, a sub-control 112 can be drawn according to its properties at the current position of the sub-control 113, and a sub-control 113 can be drawn according to its properties at the current position of the sub-control 114, thereby achieving the visual movement.

In some other embodiments of the present disclosure, the display page includes a first display area, a second display area, and a third display area. The first control is located in the first display area. As illustrated in FIG. 2A, the display page 200 includes a display area 210, a display area 220, and a display area 230. The display area 210, display area 220, and display area 230 are examples of the first display area, the second display area, and the third display area, respectively.

The display area 220 includes multiple second controls, each of which is used to display image data from one of the multiple sub-controls. For example, as illustrated in FIG. 2A, the control 130 in the display area 220 is an example of the second control, which is used to display image data from the sub-control 112 in response to the first movement operation performed on the sub-control 112.

In some embodiments of the present disclosure, the display area 230 is configured to display at least one layout strategy. Each layout strategy indicates one layout method for arranging multiple second controls, or indicates sub-controls corresponding to multiple second controls, so as to display image data from sub-controls corresponding to each second control by each second control.

In some embodiments of the present disclosure, the display area 230 is further configured to display at least one display strategy, which indicates the corresponding relationship between the layout strategy and the time period, so as to display the layout strategy corresponding to each time period within each time period.

As illustrated in FIG. 2A, for example, the display area 230 includes at least two selection options: scene and contingency. The scene selection option is used to display the layout strategy, and the contingency selection option is used to display the display strategy. When the scene selection option is selected, the display area 230 displays multiple layout strategies, such as layout strategy 1, layout strategy 2, layout strategy 3, etc.

In some embodiments of the present disclosure, each layout strategy indicates a layout method for arranging multiple second controls. In this embodiment, the arrangement method may include the amount of second controls to be displayed within the range of the display area 220, as well as the distribution of multiple second controls. For example, layout strategy 1 is the layout of display area 220 in FIG. 2A, where three second controls are displayed in the display area 220, with a larger second control 140 displayed on the left and two smaller second controls 130 and 150 displayed on the right. For example, in layout strategy 2, two smaller second controls are displayed in an area close to the display area 210, and a larger second control is displayed in an area far away from display area 210. This embodiment can flexibly adjust the layout of multiple second controls, and users can design layout strategies according to actual needs, making it easy to observe the image data displayed by the second control. For example, the second control for displaying key image data is arranged in a position that is easy to observe, and the display area of the second control for displaying key image data is relatively large.

In some other embodiments of the present disclosure, each layout strategy indicates sub-controls corresponding to the multiple second control, respectively, so that each second control can display image data from the sub-control corresponding to the second control. In this embodiment, for example, the distribution of multiple second controls in multiple layout strategies can be the same, and the sub-controls corresponding to the distribution of multiple second controls in multiple layout strategies are different. For example, the distribution of multiple second controls in the display area 220 is illustrated in FIG. 2A. In layout strategy 1, the larger control 140 on the left side of the display area 220 corresponds to sub-control 111, the control 130 corresponds to sub-control 112, and the control 150 corresponds to sub-control 113. In layout strategy 2, the control 140 corresponds to sub-control 112, the control 130 corresponds to sub-control 113, and the control 150 corresponds to sub-control 111.

For example, this operation method is applied to the large screen end of a smart city, which includes multiple streets. The sub-control 111 displays the image data of Street 1, the sub-control 112 displays the image data of Street 2, the sub-control 113 displays the image data of Street 3, the sub-control 114 displays the image data of Street 4, and so on. Layout strategy 1, for example, includes control 140 corresponding to sub-control 111, control 130 corresponding to sub-control 112, and control 150 corresponding to sub-control 113. Therefore, control 140 displays image data of Street 1, control 130 displays image data of Street 2, and control 150 displays image data of Street 3. Layout strategy 2, for example, includes control 140 corresponding to sub-control 112, control 130 corresponding to sub-control 113, and control 150 corresponding to sub-control 114. Therefore, control 140 displays image data of Street 2, control 150 displays image data of Street 4, and control 130 displays image data of Street 3.

When the plan selection option in the display area 230 is selected, the display area 230 displays multiple display strategies. The display strategy indicates the corresponding relationship between the layout strategy and the time period, so as to display the layout strategy corresponding to each time period within each time period.

For example, the display strategies include display strategy 1, display strategy 2, display strategy 3, etc. Display strategy 1 displays according to layout strategy 1 during the time period of [a1, a2), displays according to layout strategy 2 during the time period of [a2, a3), displays according to layout strategy 3 during the time period of [a3, a4), and so on.

For example, in the application scenario of the smart city mentioned above, during the time period of [a1, a2), displaying is performed according to layout strategy 1, which means that the larger control 140 displays the image data of Street 1 for easy viewing. During the time period of [a2, a3), displaying is performed according to layout strategy 2, and the larger control 140 displays the image data of Street 2 for easy viewing. This method can display multiple scenes (for example, streets) according to different layout strategies for different time periods, thus making the display focus of touch screen different, thereby making it easier for users to view image data, improving the flexibility of displaying image data, and improving the user experience. For example, if Street 1 includes a park and Street 2 includes a school, the larger control 140 displays the image data of Street 1 at [6:00, 7:00), and the larger control 140 displays the image data of Street 2 at [7:00, 9:00). This facilitates users to set key observation street scenes based on the particularity of each time period, thereby improving the user experience.

In some embodiments of the present disclosure, for example, the display page 200 is displayed on a touch screen, which can be externally connected to a splicing screen, and the splicing screen includes multiple external display screens. For example, the touch screen can obtain image data from multiple external display screens and display the image data in multiple second controls.

In some embodiments of the present disclosure, for example, the correspondence between multiple second controls and multiple external display screens is determined based on user settings, and each second control displays image data of the external display screen corresponding to each second control. For example, each sub-control in control 110 of display page 200 corresponds to one external display screen to display image data of the external display screen. Users can drag the sub-control to the second control located in the second display area, and the image data in the sub-control is displayed by the second control, that is, the second control corresponds to the external display screen corresponding to the sub-control. For example, users can configure the external display screens corresponding to the multiple second controls through direct input, respectively.

In some embodiments of the present disclosure, the layout of multiple second controls can be the same as the layout of the splicing screen, so as to restore the display screen of the splicing screen on the touch screen.

In the above embodiments disclosed in the present disclosure, users can set different layout strategies to enable multiple controls in the second display area to display multiple image data reasonably, thus avoiding image overflow from the display area of the control or insufficient utilization of the display area of the control due to the small image size, thereby meeting various display needs of users. For example, the splicing screen includes an external display screen 1, an external display screen 2, and an external display screen 3. The second display area includes a control 130, a control 140, and a control 150, The control 130 corresponds to the external display screen 1, the control 140 corresponds to the external display screen 2, and the control 150 corresponds to the external display screen 3. If the external display screen 3 is larger than the external display screen 1 and the external display screen 2, the layout strategy in the display area 220 in FIG. 2A can be adjusted, such as enlarging the control 150, and zooming out the control 130 and the control 140, so that the image data of the external display screen 3 can be fully and clearly displayed in the control 150, thereby avoiding the image from overflowing from the display area of the control. For example, by adjusting the external display screen 3 from corresponding to the control 150 to corresponding to the control 140, and adjusting the external display screen 2 from corresponding to the control 140 to corresponding to the control 150, the control 140 displays the image data of the external display screen 3, and the control 150 displays the image data of the external display screen 2.

In some embodiments of the present disclosure, the first control, the first sub-control, and the second control are obtained based on a cross-platform interface development framework or an operating system.

For example, all controls and sub-controls in the present disclosure are obtained based on a cross-platform interface development framework (such as Flutter), or all controls and sub-controls in this disclosure are obtained based on an operating system (such as Android or Windows).

For example, Flutter provides the Draggable component, which has a GestureRecognizer class that handles gesture related tasks. For example, in some embodiments of this disclosure, drag controls are obtained through the Draggable component provided by Flutter.

For example, in some embodiments of the present disclosure, the list control is obtained through the Scoller component provided by Flutter.

For example. Flutter listens for gesture events through the GestureRecognizer class, and the takeover and discarding of gestures can be handled by the internal logic of the GestureRecognizer class. All gestures can be dispatched and processed in the GestureBinding class provided by Flutter. The components that need to handle gestures are determined by using the HitTest method provided by Flutter. and the components are added to the path of HitTestResult. All components that need to handle gestures are placed in the arena, and each component may have its own response conditions to obtain control right (such as the first response condition and second response condition). When the gesture meets the response condition of one component, this component can actively obtain control right, and other components lose the right to handle gestures. If the response conditions for multiple components to obtain control right are the same and the conditions are met first, control right is handed over to the component firstly added to the arena. If there is only one component in the arena, the operation control system directly hands over gesture control right to the component. If the gesture changes but the condition does not meet the response conditions of any component, the operation control system may hand over control right to the component without configured response conditions. The first movement operation and second movement operation in this disclosure can be a gesture, for example, so as to use Flutter to operate the controls and sub-controls displayed on the touch screen.

For example, in some embodiments of the present disclosure, the list control is not configured with response conditions. When it is determined that the slide distance is greater than the distance threshold and the response conditions of other components are not met, the operation control system actively gives gesture control right to the list control.

In some embodiments of the present disclosure, if the distance that the finger moves with is greater than the distance threshold, the drag control does not apply for control right when the angle between the slide direction of the slide operation and the extension direction of the list control is within the preset range. In this case, the operation control system hands over control right to the list control. When the angle between the slide direction of the slide operation and the extension direction of the list control is outside the preset range, the drag control applies for control right.

For example, the disclosed embodiments can also be implemented through the Android operating system. In the Android operating system, a component is an independent View or a ViewGroup composed of several Views. When the finger touches the screen, the Android operating system passes the touch event (touch) down from the top-level component (DecorView). If it is a ViewGroup, it will continue to pass to the child Views. If a certain View wants to process the touch event, it needs to intercept and consume the event, this is achieved by returning true in the dispatchTouchEvent method. If the deepest View is reached without consumption, the triggering event will be returned and handed over to the higher-level View for processing. For example, a list control is the higher-level View of a drag control. When the user performs a slide operation on the touch screen, the slide direction of the slide operation is passed to the drag control. If the angle between the slide direction and the extension direction of the list control is within the preset range, the drag control does not consume the slide operation, but returns it to the list control of higher-level, and the list control responds to the slide operation. If the angle between the slide direction and the extension direction of the list control is outside the preset range, the drag control consumes the slide operation to respond to the slide operation.

For a gesture (such as a slide operation), the processing mechanism of Flutter is that as long as a component (such as the Scoller component of a list control, Draggable component, etc.) obtains control right, this component responds to the gesture until the gesture ends. For example, in the scenario illustrated in FIG. 2A, once control right is obtained by the sub-control 112, it is not needed to determine which component to delegate control right again and the sub-control 112 has control right during the process of sliding the finger from the corresponding position of the sub-control 112 to the position of the second control 130. In Android, intercepting and consuming for touch events aims at every movement. For example, in the scenario illustrated in FIG. 2A, during the process of sliding the finger from the position corresponding to the sub-control 112 to the position of the second control 130, each movement of the finger requires interception and consumption of touch events. Therefore, by using Flutter to obtain controls and sub-controls, response speed can be improved and resources can be saved.

In some embodiments of the present disclosure, as illustrated in FIG. 2A, the display area 220 includes multiple second controls, each of which can, for example, display 3D image data. For example, display page 200 can include a data display panel layer and a 3D model display layer. The data display panel layer is used to provide a user interface (UI). For example, the data display panel layer can provide a two-dimensional user interface or a three-dimensional user interface. The data display panel layer can be obtained by using the Flutter development framework. For example, the controls and sub-controls in the display page 200 are provided by the data display panel layer.

In some embodiments of the present disclosure, 3D image data is displayed through the 3D model display layer. For example, the 3D model display layer is developed based on OpenSceneGraph (OSG). OSG is a graphics development package with characteristics of open source and cross platform, and is designed for high-performance graphics application development such as aircraft simulation, games, virtual reality, and scientific computing visualization. OSG provides an object-oriented framework on the open graphics library (OpenGL), which frees developers from implementing and optimizing low-level graphics calls. It also provides many additional practical tools for rapid development of graphics applications.

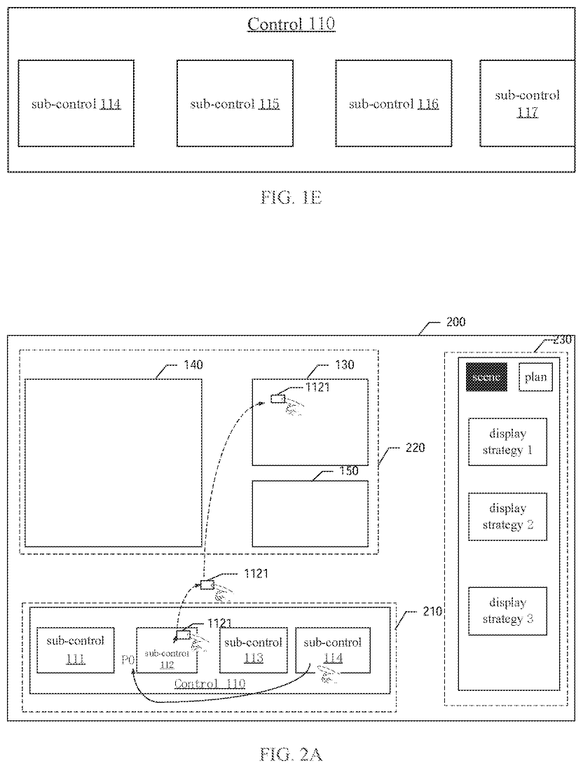

FIG. 4 is a schematic block diagram of an operation apparatus provided by at least one of the embodiments of the present disclosure.

For example, as illustrated in FIG. 4, the operation apparatus 400 includes an acquiring unit 410, a first response unit 420, and a second response unit 430.

The acquiring unit 410 is configured to acquire a first movement operation which is performed on a first sub-control in a first control. The first sub-control is located in an area range of the first control.

The acquiring unit 410 can perform step S10 described in FIG. 1A, for example.

The first response unit 420 is configured to respond to the first movement operation by the first control in response to the first movement operation meeting a first response condition of the first control and meeting a second response condition of the first sub-control.

The first response unit 420 can perform step S20 as described in FIG. 1A, for example.

The second response unit 430 is configured to respond to the first movement operation by the first sub-control to generate visual movement in response to the first movement operation not meeting the first response condition but meeting the second response condition.

The second response unit 430 can perform step S30 as described in FIG. 1A, for example.

This operation apparatus can alleviate the problem of operational conflicts between controlling the first control and controlling the first sub-control.

For example, the acquiring unit 410, the first response unit 420, and the second response unit 430 may be hardware, software, firmware, or any feasible combination thereof. For example, the acquiring unit 410, the first response unit 420, and the second response unit 430 may be specialized or general-purpose circuits, chips, or devices, or a combination of a processor and a memory. The specific implementation forms of each unit mentioned above are not limited by the disclosed embodiments.

It should be noted that in the embodiments of the present disclosure, each unit of the operation apparatus 400 corresponds to each step of the aforementioned operation method. For specific functions of the operation apparatus 400, references can be made to the relevant description of the operation method, which will not be repeated here. The components and structure of the operation apparatus 400 illustrated in FIG. 4 are only exemplary and not restrictive, and as needed, the operation apparatus 400 may also include other components and structures.

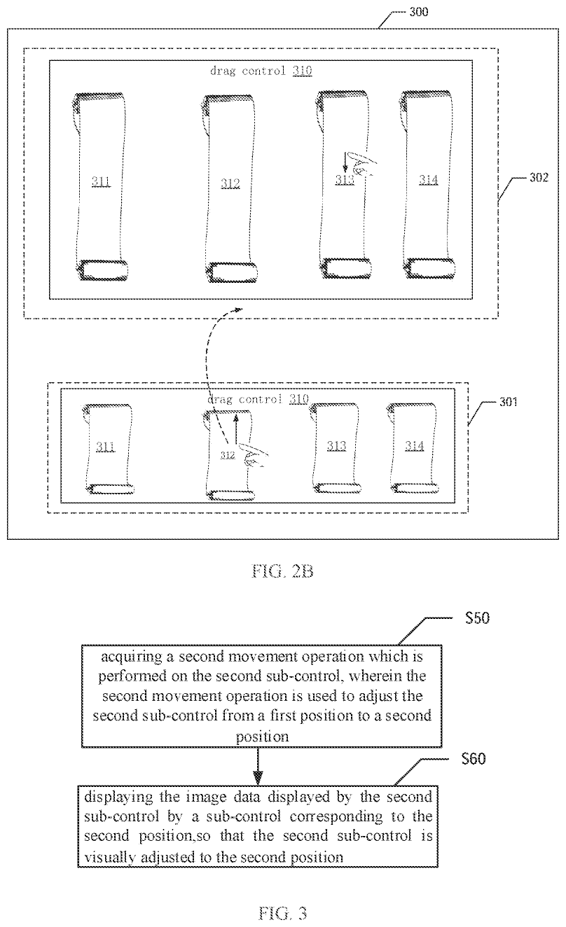

FIG. 5 is a schematic block diagram of an electronic device provided by at least one of the embodiments of the present disclosure. As illustrated in FIG. 5, the electronic device 500 includes a processor 510 and a memory 520. The memory 520 is used to store non-volatile computer-readable instructions (such as one or more computer program modules). The processor 510 is used to run the non-volatile computer-readable instructions, which can execute one or more steps of the operation methods described above when run by the processor 510. The memory 520 and the processor 510 can be interconnected through a bus system and/or other forms of connection mechanisms (not illustrated).

For example, the processor 510 can be a central processing unit (CPU), graphics processing unit (GPU), or other forms of processing unit with data processing and/or program execution capabilities. For example, the central processing unit (CPU) can be with X86 or ARM architecture. The processor 510 can be a general-purpose or specialized processor that can control other components in the electronic device 500 to perform desired functions.

For example, the memory 520 may include any combination of one or more computer program products, which may include various forms of computer-readable storage media, such as volatile memory and/or non-volatile memory. Volatile memory may include, for example, random access memory (RAM) and/or cache memory. Non-volatile memory may include, for example, read-only memory (ROM), hard disk, erasable programmable read-only memory (EPROM), portable compact disc read-only memory (CD-ROM), USB memory, flash memory, etc. One or more computer program modules can be stored on the computer-readable storage medium, and the processor 510 can run the one or more computer program modules to achieve various functions of the electronic device 500. In the computer-readable storage media, various applications and data, as well as various data used and/or generated by applications, can also be stored.

It should be noted that in the disclosed embodiment, the specific functions and technical effects of the electronic device 500 can be referred to the description of the operation method in the previous text, and will not be repeated here.

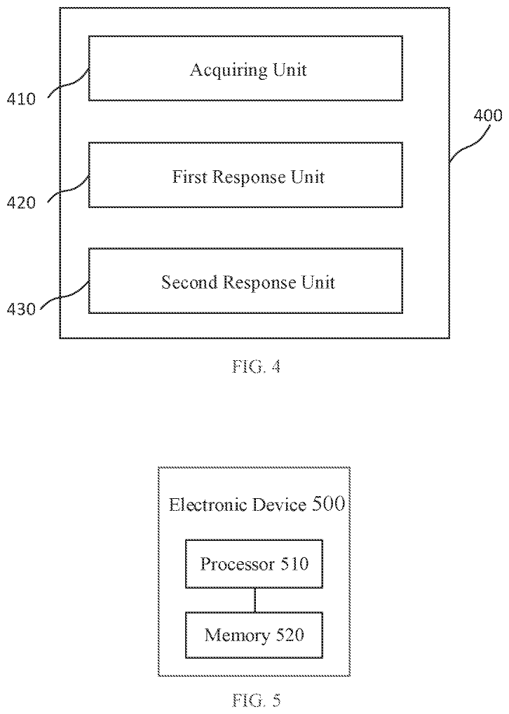

FIG. 6 is another schematic block diagram of an electronic device provided by at least one of the embodiments of the present disclosure. The electronic device 600 is suitable for implementing the operation methods provided by the disclosed embodiments, for example. Electronic device 600 can be a terminal device or the like. It should be noted that the electronic device 600 illustrated in FIG. 6 is only an example and does not impose any limitations on the functionality and scope of use of the disclosed embodiments.

As illustrated in FIG. 6, the electronic device 600 may include a processing device (such as a central processing unit, graphics processor, etc.) 610, which may perform various appropriate actions and processes based on programs stored in the read-only memory (ROM) 620 or programs loaded from the storage device 680 into the random access memory (RAM) 630. In RAM 630, various programs and data required for the operation of the electronic device 600 are also stored. The processing devices 610, ROM 620, and RAM 630 are connected to each other through bus 640. The input/output (I/O) interface 650 is also connected to bus 640.

Typically, the following devices can be connected to the I/O) interface 650: an input device 660 including, for example, touch screen, touchpad, keyboard, mouse, camera, microphone, accelerometer, gyroscope, etc.: an output device 670 such as liquid crystal displays (LCDs), speakers, vibrators, etc.; a storage device 680 such as magnetic tapes, hard drives, etc.; and a communication device 690. The communication device 690 can allow the electronic device 600 to communicate wirelessly or in wired way with other electronic devices to exchange data. Although FIG. 6 illustrates the electronic device 600 with various devices, it should be understood that it is not required to implement or have all the illustrated devices, and the electronic device 600 can alternatively implement or have more or fewer devices.

For example, according to the embodiments of the present disclosure, the above operation method can be implemented as a computer software program. For example, the disclosed embodiments include a computer program product that includes a computer program carried on a non-volatile computer-readable medium, and the computer program includes program codes for executing the aforementioned operation method. In such embodiments, the computer program can be downloaded and installed from the network through the communication device 690, or installed from the storage device 680, or installed from ROM 620. When the computer program is executed by the processing device 610, the functions defined in the operation method provided by the present disclosed embodiments can be implemented.

At least one embodiment of the present disclosure also provides a computer-readable storage medium for storing non-volatile computer-readable instructions. The aforementioned operation method can be implemented when the non-volatile computer-readable instructions are executed by a computer. By utilizing this computer-readable storage medium, the problem of operational conflicts between controlling the first control and controlling the first sub-control can be alleviated.

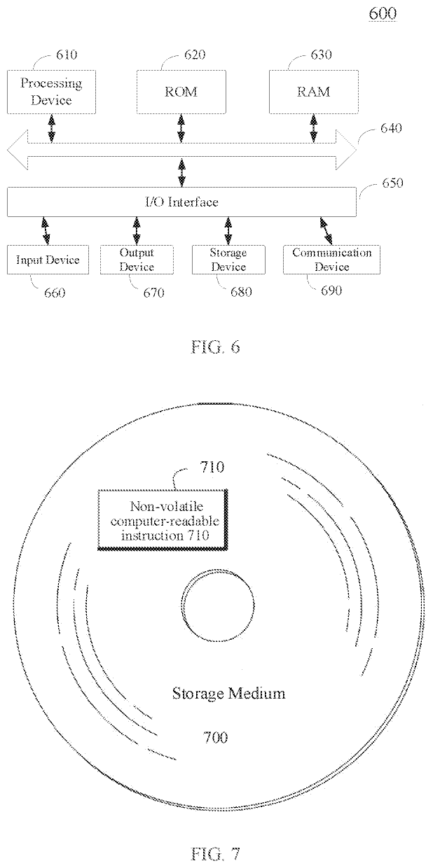

FIG. 7 is a schematic diagram of a storage medium provided by some embodiments of the present disclosure. As illustrated in FIG. 7, the storage medium 700 is used for storage of computer-readable instruction 710 in a non-volatile way. For example, when the computer-readable instruction 710 is executed by a computer, one or more steps of the operation method described above can be executed.

For example, the storage medium 700 can be applied to the electronic device 500 mentioned above. For example, the storage medium 700 can be the memory 520 in the electronic device 500 illustrated in FIG. 5. For example, the relevant description of the storage medium 700 can be referred to the corresponding description of the memory 520 in the electronic device 500 illustrated in FIG. 5, which may not be repeated here.

The following is to be noted:
(1) The drawings of the present disclosure only relate to the structures relevant to the embodiments of the present disclosure, and other structures may be referred to the common design;
(2) In the case of no conflict, the embodiments of the present disclosure and the features of the embodiments may be combined with each other to obtain new embodiments.

What have been described above are only specific implementations of the present disclosure, the protection scope of the present disclosure is not limited thereto, and the protection scope of the present disclosure should be based on the protection scope of the claims.

1. An operation method, comprising:
acquiring a first movement operation which is performed on a first sub-control in a first control, wherein the first sub-control is located in an area range of the first control;
in response to the first movement operation meeting a first response condition of the first control and meeting a second response condition of the first sub-control, responding to the first movement operation by the first control; and
in response to the first movement operation not meeting the first response condition but meeting the second response condition, responding to the first movement operation by the first sub-control to generate visual movement.

2. The method of claim 1, wherein the first control comprises a list control, the first sub-control comprises a drag control, and the drag control is a control which is capable of being dragged.

3. The method of claim 1, wherein N sub-controls are in the area range of the first control, N is an integer greater than 1, the N sub-controls are arranged in the first control in sequence, and the first sub-control is one of the N sub-controls.

4. The method of claim 3, wherein the first control comprises a list control, and
in response to the first movement operation meeting the first response condition of the first control and meeting the second response condition of the first sub-control, responding to the first movement operation by the first control, comprises:
in response to the first movement operation meeting the first response condition and meeting the second response condition, by the list control, visually rolling the N sub-controls in the list control.

5. The method of claim 1, wherein the first movement operation comprises a slide operation.

6. The method of claim 5, wherein the first response condition is a subset of the second response condition.

7. The method of claim 6, wherein the second response condition comprises: a slide distance of the slide operation being greater than a distance threshold; and
the first response condition comprises: the slide distance of the slide operation being greater than the distance threshold, and a slide direction of the slide operation being within a preset range.

8. The method of claim 5, wherein the first response condition comprises: a slide distance of the slide operation being greater than a distance threshold, and a slide direction of the slide operation being within a preset range; and
the second response condition comprises: the slide distance of the slide operation being greater than the distance threshold, and the slide direction of the slide operation being outside the preset range.

9. The method of claim 7, wherein the slide direction of the slide operation being within the preset range comprises:
an angle between the slide direction of the slide operation and an extension direction of the first control being within the preset range.

10. The method of claim 9, wherein the extension direction is a horizontal direction, and in response to a first distance sliding by the slide operation in the horizontal direction being greater than a second distance sliding by the slide operation in a vertical direction, the angle between the slide direction and the extension direction of the first control is within the preset range; or
the extension direction is the vertical direction, and in response to the first distance sliding by the slide operation in the horizontal direction being less than the second distance sliding by the slide operation in the vertical direction, the angle between the slide direction and the extension direction of the first control is within the preset range,
wherein the horizontal direction is perpendicular to the vertical direction.

11. The method of claim 2, wherein, in response to the first movement operation not meeting the first response condition but meeting the second response condition, responding to the first movement operation by the first sub-control to generate visual movement, comprises:
in response to the first movement operation not meeting the first response condition but meeting the second response condition, generating an auxiliary control of the drag control; and
allowing the auxiliary control to move with the first movement operation.

12. The method of claim 11, wherein the auxiliary control moves outside the area range of the first control according to the first movement operation.

13. The method of claim 12, wherein the first control and the first sub-control are displayed on a display page, the display page further comprises a second control which is outside the area range of the first control, the first sub-control comprises a display window and displays image data, and
the method further comprises:
in response to the auxiliary control moving into an area range of the second control and stopping moving, providing the image data to the second control by the first sub-control, and displaying the image data by a display window of the second control.

14. The method of claim 13, wherein a second sub-control is within the area range of the first control, and
the method further comprises:
acquiring a second movement operation which is performed on the second sub-control, wherein the second movement operation is used to adjust the second sub-control from a first position to a second position; and
displaying the image data displayed by the second sub-control by a sub-control corresponding to the second position.

15. The method of claim 14, wherein the second movement operation comprises a press operation to the second sub-control and a selecting operation to the second position, and a duration of the press operation is longer than a preset duration.

16. The method of claim 13, wherein the display page comprises a first display area, a second display area, and a third display area, the first control is located in the first display area,
the second display area comprises a plurality of second controls, each second control is used for displaying image data from one of a plurality of sub-controls,
the third display area is configured to display at least one layout strategy, each layout strategy indicates a layout method used for arranging the plurality of second controls, or indicates sub-controls respectively corresponding to the plurality of second controls, so as to allow each second control to display image data from a sub-control corresponding to the second control.

17. The method of claim 16, wherein the third display area is further configured to display at least one display strategy, and the display strategy indicates relationship between the layout strategy and a time period, so as to display the layout strategy corresponding to each time period in each time period.

18-19. (canceled)

20. An operation apparatus, comprising:
an acquiring unit, configured to acquire a first movement operation which is performed on a first sub-control in a first control, wherein the first sub-control is located in an area range of the first control;
a first response unit, configured to respond to the first movement operation by the first control in response to the first movement operation meeting a first response condition of the first control and meeting a second response condition of the first sub-control; and
a second response unit, configured to respond to the first movement operation by the first sub-control to generate visual movement in response to the first movement operation not meeting the first response condition but meeting the second response condition.

21. An electronic device, comprising:
a processor; and
a memory, comprising one or more computer program instructions,
wherein the one or more computer program instructions are stored in the memory, and implement the operation method according to claim 1 when executed by the processor.

22. A computer-readable storage medium, storing computer-readable instructions in a nonvolatile way, wherein when the computer-readable instructions are executed by a processor, the operation method according to claim 1 is implemented.
